(19) United States
(12) Patent Application Publication
(10) Pub. No.: US 2019/0147273 A1
(43) Pub. Date: May 16, 2019

(54) ALERT CONTROL APPARATUS, METHOD, AND PROGRAM

(71) Applicant: OMRON Corporation, Kyoto-shi (JP)

(72) Inventors: Tadashi HYUGA, Hirakata-shi (JP); Tomoyoshi AIZAWA, Kyoto-shi (JP); Hatsumi AOI, Kyotanabe-shi (JP); Yoshio MATSUURA, Kasugai-shi (JP); Masato TANAKA, Kizugawa-shi (JP); Keisuke YOKOTA, Kasugai-shi (JP); Hisashi SAITO, Kasugai-shi (JP)

(73) Assignee: OMRON Corporation, Kyoto-shi (JP)

(21) Appl. No.: 16/179,984

(22) Filed: Nov. 4, 2018

(30) Foreign Application Priority Data
Nov. 15, 2017 (JP) 2017-219863

(51) Int. Cl. G06K 9/00; B60W 50/14; B60W 40/09

(52) U.S. Cl. CPC G06K 9/00845; B60W 50/14; B60W 40/09; B60W 2550/10; B60W 2540/18; B60W 2550/14; B60W 2050/143

(57) ABSTRACT

An alert control apparatus includes a first obtaining unit that obtains first information about a gaze or face orientation of a driver, a distracted driving determiner that outputs a detection signal when detecting distracted driving, a second obtaining unit that obtains second information indicating whether an intersection is recognized, a third obtaining unit that obtains third information about a change in a vehicle traveling direction, an alert disabling unit that outputs a disabling signal disabling the detection signal in response to the intersection recognized and the traveling direction change detected, and an alert controller that outputs an instruction signal for an alert device to generate an alert in response to the detection signal output without the disabling signal, and outputs no instruction signal in response to the detection signal output with the disabling signal.

### CROSS-REFERENCE TO RELATED APPLICATION

This application claims priority to Japanese Patent Application No. 2017-219863 filed on Nov. 15, 2017, the entire disclosure of which is incorporated herein by reference.

### FIELD

The present invention relates to an alert control apparatus, a method, and a program for controlling an alert device for a vehicle.

### BACKGROUND

Alert devices for vehicles have recently been developed to generate an alert to distracted driving, as described in, for example, Patent Literature 1 (Japanese Unexamined Patent Application Publication No. 2001-138767).

This type of alert device alerts the driver when detecting distracted driving of a driver based on his or her face orientation or gaze using an image of the driver captured with an interior view camera.

### SUMMARY

### Technical Problem

However, such known alert devices may have issues described below.

For example, a driver intending to change the vehicle's traveling direction by turning left at an intersection may more carefully check the surroundings than during straight driving for an object such as a motorcycle approaching from the left rear or a pedestrian on a sidewalk.

To change the traveling direction at the intersection, the driver changes his or her face orientation or gaze more widely and more frequently than in straight driving. An alert device may erroneously determine such a change as distracted driving and generate an alert.

One or more aspects of the present invention are directed to an alert control apparatus, a method, and a program for preventing an alert device from generating an unintended alert when a vehicle changes the vehicle traveling direction at an intersection.

In response to the above issue, the aspects of the present invention may be implemented in the manner described below.

An alert control apparatus according to a first aspect of the present invention includes a first obtaining unit that obtains first information about a gaze or a face orientation of a driver of a vehicle, a distracted driving determiner that determines whether the driver is engaging in distracted driving based on the gaze or the face orientation of the driver indicated by the first information and a determination condition for detecting distracted driving, and outputs a detection signal when detecting distracted driving, a second obtaining unit that obtains second information indicating whether an intersection is recognized ahead of the vehicle in a traveling direction, a third obtaining unit that obtains third information about a change in the traveling direction of the vehicle, an alert disabling unit that outputs a disabling signal for disabling the detection signal output from the distracted driving determiner in response to the intersection being recognized and the change in the traveling direction being detected based on the second information and the third information, and an alert controller that outputs an instruction signal for an alert device to generate an alert in response to the detection signal being output without the disabling signal being output, and outputs no instruction signal in response to the detection signal being output with the disabling signal being output.

An alert control apparatus according to a second aspect of the present invention is the alert control apparatus according to the first aspect further including an alert enabling unit that outputs an enabling signal to the alert controller to stop output of the disabling signal to the alert controller in response to the vehicle being determined to have passed the intersection based on the second information.

An alert control apparatus according to a third aspect of the present invention is the alert control apparatus according to the first aspect further including a fourth obtaining unit that obtains fourth information indicating whether an obstacle with a possibility of colliding with the vehicle is detected, and an alert enabling unit that outputs an enabling signal to the alert controller to stop output of the disabling signal to the alert controller in response to the obstacle being detected based on the fourth information.

An alert control apparatus according to a fourth aspect of the present invention is the alert control apparatus according to the third aspect in which the fourth obtaining unit obtains information output from an exterior sensor that detects a state surrounding the vehicle and/or information obtained from another vehicle or a system, and obtains, based on the obtained information, the fourth information indicating whether an obstacle with a possibility of colliding with the vehicle is detected.

An alert control apparatus according to a fifth aspect of the present invention is the alert control apparatus according to the first aspect in which the second obtaining unit obtains at least image information obtained by an exterior view camera installed on the vehicle to capture an image in front of the vehicle, position information about the vehicle measured by a position measurement sensor installed on the vehicle, or traffic information received by an exterior information obtaining unit installed on the vehicle, and obtains, based on the obtained information, the second information indicating whether an intersection is recognized ahead of the vehicle in the traveling direction.

An alert control apparatus according to a sixth aspect of the present invention is the alert control apparatus according to the first aspect in which the third obtaining unit obtains at least operation information about a direction indicator installed on the vehicle, steering angle information about a steering unit installed on the vehicle, yaw rate information obtained by a yaw rate sensor installed on the vehicle, or lateral acceleration information obtained by a lateral acceleration sensor installed on the vehicle, and obtains, based on the obtained information, the third information about a change in the traveling direction of the vehicle.

A method according to a seventh aspect of the present invention is implemented by an alert control apparatus for controlling an alert device installed on a vehicle. The method includes obtaining, with the alert control apparatus, first information about a gaze or a face orientation of a driver, determining, with the alert control apparatus, whether the driver is engaging in distracted driving based on the gaze or the face orientation of the driver indicated by the first information and a determination condition for detecting distracted driving, and outputting a detection signal when detecting distracted driving, obtaining, with the alert control apparatus, second information indicating whether an intersection is recognized ahead of the vehicle in a traveling direction, obtaining, with the alert control apparatus, third information about a change in the traveling direction of the vehicle, outputting, with the alert control apparatus, a disabling signal for disabling the detection signal in response to the intersection being recognized and the change in the traveling direction being detected based on the second information and the third information, and outputting, with the alert control apparatus, an instruction signal for the alert device to generate an alert in response to the detection signal being output without the disabling signal being output, and outputting no instruction signal, with the alert control apparatus, in response to the detection signal being output with the disabling signal being output.

A program according to an eighth aspect of the present invention causes a computer to function as the units included in the alert control apparatus according to any one of the first to sixth aspects.

### Advantageous Effects

The apparatus, method, and program according to the first, seventh, and eighth aspects of the present invention can disable a distracted driving alert in response to an intersection being recognized and a change of a traveling direction of a vehicle being detected until the vehicle finishes passing the intersection. The apparatus, method, and program prevent an unintended alert from being generated for a checking action of the driver at intersection.

The apparatus according to the second aspect of the present invention enables the distracted driving alert after the vehicle has passed the intersection. Thus, the alert device can generate an alert in response to distracted driving of the driver being detected after the vehicle has passed the intersection.

The apparatus according to the third aspect of the present invention maintains an operation for generating a distracted driving alert to be active without disabling the distracted driving alert in response to an obstacle being detected when an intersection is being recognized. Thus, the alert device can generate an alert in response to distracted driving of the driver being detected when the driver is expected to recognize an obstacle.

The apparatus according to the fourth aspect of the present invention can detect an obstacle more accurately based on information obtained from the vehicle exterior.

The apparatus according to the fifth aspect of the present invention can recognize an intersection more accurately based on at least the image information from the exterior view camera, the position information about the vehicle, or the traffic information.

The apparatus according to the sixth aspect of the present invention can detect an operation to change the traveling direction of the vehicle more accurately based on at least the operation information about the direction indicator, the steering angle information, the yaw rate information, or the lateral acceleration information.

### BRIEF DESCRIPTION OF THE DRAWINGS

FIG. 1 is a schematic diagram of a vehicle including an alert control apparatus implementing an alert control method according to one or more embodiments of the present invention.

FIG. 2 is a functional block diagram of an alert control apparatus according to a first embodiment.

FIG. 3 is a flowchart showing an example operation performed by the alert control apparatus according to the first embodiment.

FIG. 4 is a functional block diagram of an alert control apparatus according to a second embodiment.

FIG. 5 is a flowchart showing an example operation performed by the alert control apparatus according to the second embodiment.

### DETAILED DESCRIPTION

Embodiments of the present invention will be described below with reference to the drawings.

### Example Use

### Structure

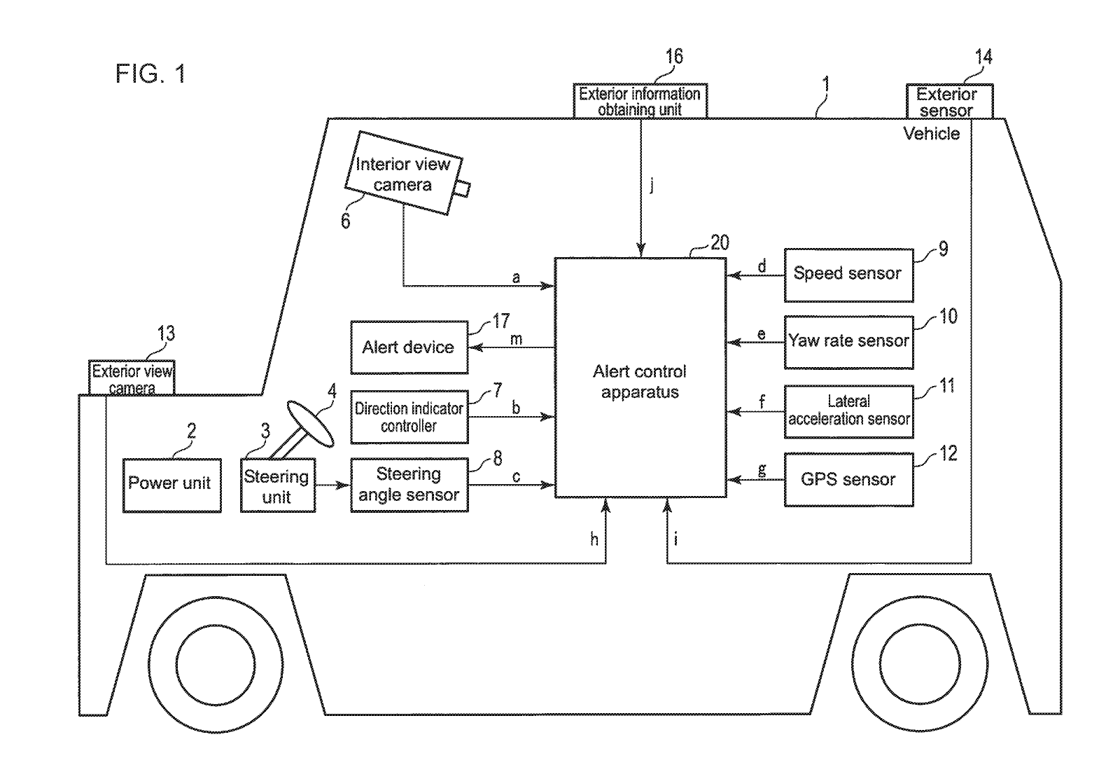

An example of an alert control apparatus implementing an alert control method according to one or more embodiments of the present embodiment will now be described with reference to FIG. 1.

FIG. 1 is a schematic diagram of a vehicle including an alert control apparatus implementing an alert control method according to one embodiment.

A vehicle 1 typically includes, as its basic components, a power unit 2 including a power supply and a speed changer, and a steering unit 3 incorporating a steering wheel 4. The vehicle 1 further includes a transmission for transmitting power generated by the power unit 2 to the wheels, a controller for controlling driving, and various sensors used for controlling the controller. To simplify the drawing, FIG. 1 does not show these components. FIG. 1 simply shows an alert control apparatus 20 and components associated with the alert control apparatus 20, including an interior view camera 6, a direction indicator controller 7, a steering angle sensor 8, a speed sensor 9, a yaw rate sensor 10, a lateral acceleration sensor 11, a position measurement sensor, such as a global positioning system (GPS) sensor 12, an exterior view camera 13, an exterior sensor 14, an exterior information obtaining unit 16, and an alert device 17.

The alert control apparatus 20 obtains data such as image data, sensing data, received data, and state data from the interior view camera 6, the direction indicator controller 7, the steering angle sensor 8, the speed sensor 9, the yaw rate sensor 10, the lateral acceleration sensor 11, the GPS sensor 12, the exterior view camera 13, the exterior sensor 14, and the exterior information obtaining unit 16. While the vehicle 1 is traveling, the alert control apparatus 20 operates the alert device 17. In response to distracted driving of the driver being detected based on the above data, the alert control apparatus 20 causes the alert device 17 to generate a distracted driving alert.

While the vehicle 1 is traveling, the alert control apparatus 20 disables a distracted driving alert in response to an intersection being recognized and an operation to change the traveling direction of the vehicle 1 for turning right or left being detected until the vehicle 1 finishes passing the intersection. Thus, the alert control apparatus 20 prevents an unintended alert from being generated for a checking action of the driver at the intersection. After the vehicle 1 finishes passing the intersection, the alert control apparatus 20 enables the distracted driving alert.

When detecting an obstacle with a possibility of colliding with the vehicle, the alert control apparatus 20 does not disable distracted driving alert irrespective of an intersection being recognized. Examples of the obstacle with a possibility of colliding with the vehicle include other vehicles or pedestrians located within a predetermined distance ahead of the intersection in the traveling direction. The predetermined distance is, for example, a distance of about 1 to 10 m. Examples of other vehicles include a vehicle traveling ahead or a vehicle stopped before the intersection. Examples of pedestrians include people on a crosswalk or road. The alert device 17 can thus resume generating an alert in response to distracted driving of a driver being detected and an obstacle being detected while the vehicle is traveling at the intersection.

The interior view camera 6 is installed on the vehicle interior in front of a driver on, for example, the dashboard. The interior view camera 6 captures an image of the driver, and outputs an image data signal a to the alert control apparatus 20. The interior view camera 6 may start capturing images of the driver in response to a request from the alert control apparatus 20 or may constantly capture such images during the operation of the vehicle 1 with or without a request from the alert control apparatus 20.

The direction indicator controller 7 turns on a direction indicator (blinker) based on an operation performed by the driver on a column switch for the vehicle 1 to turn right or left or change the lane. The direction indicator controller 7 outputs, to the alert control apparatus 20, a direction indicator signal b corresponding to a direction to which the vehicle 1 is redirected to turn right or left or change the lane. The alert control apparatus 20 may obtain the direction indicator signal b output from the direction indicator controller 7.

The steering angle sensor 8 outputs, to the alert control apparatus 20, a steering angle signal c corresponding to the steering direction, the neutral position, and the steering angle in accordance with the operation of the steering unit 3.

The speed sensor 9 detects the speed of the vehicle 1, and outputs a detection signal d corresponding to the detected speed to the alert control apparatus 20.

The yaw rate sensor 10 detects the yaw rate of the vehicle 1, and outputs a detection signal e corresponding to the detected yaw rate to the alert control apparatus 20.

The lateral acceleration sensor 11 detects a lateral acceleration of the vehicle 1, and outputs a detection signal f corresponding to the detected lateral acceleration to the alert control apparatus 20.

The GPS sensor 12 detects position information for the vehicle 1, and outputs a detection signal g corresponding to the detected position information to the alert control apparatus 20. The detected position information may be used in, for example, recognizing intersections.

The exterior view camera 13 is installed at the front or side of the vehicle 1 to capture surrounding images of the vehicle 1, and outputs an image data signal h to the alert control apparatus 20. The captured image data may be used in, for example, recognizing intersections or obstacles.

The exterior sensor 14 recognizes the surroundings of the vehicle. The exterior sensor 14, like an infrared sensor or a radar, detects the state of objects around the vehicle and transmits, for example, a state information signal i. The exterior sensor 14, which may be an infrared sensor or a radar, measures a distance to an object around the vehicle 1, and outputs the state information signal i corresponding to the measured distance to the alert control apparatus 20. This vehicle-surrounding information may be used in, for example, recognizing intersections or obstacles.

The exterior information obtaining unit 16 receives traffic information transmitted from the Vehicle Information and Communication System (VICS, registered trademark) (not shown) or other information transmitted from other vehicles, and outputs a reception signal j to the alert control apparatus 20. The exterior information may be used in, for example, recognizing intersections or obstacles.

The alert device 17 is installed on the vehicle interior. The alert device 17 generates an alert in response to an alert instruction signal m from the alert control apparatus 20. Examples of an alert include, in addition to a buzzer sound, a display of characters or figures, light emission, vibrations, and communication to mobile terminals.

### Advantages and Effects

When the vehicle 1 is traveling on a road other than intersections or traveling straight across the intersection, the alert control apparatus 20 with the above structure operates the alert device 17. In response to distracted driving of the driver being detected based on various types of data, the alert control apparatus 20 in this state causes the alert device 17 to generate an alert.

While the vehicle 1 is traveling, the distracted driving alert is disabled in response to an intersection being recognized based on, for example, the position information detected by the GPS sensor 12, the image data captured by the exterior view camera 13, the measurement results from the exterior sensor 14, or exterior information obtained by the exterior information obtaining unit 16, and in response to an operation to change the traveling direction of the vehicle 1 to turn right or left being detected. The alert control apparatus 20 thus prevents generation of an unintended alert that can disturb concentration of the driver checking the surroundings at the intersection. After the vehicle 1 has passed the intersection, the distracted driving alert is enabled. The alert device 17 can resume generating an alert in response to distracted driving being detected.

The alert control apparatus 20 does not disable the distracted driving alert in response to detection of an obstacle irrespective of an intersection being recognized. Thus, the alert device 17 can generate an alert in response to detection of an obstacle with a possibility of colliding with the vehicle and detection of distracted driving of the driver during traveling at the intersection.

### First Embodiment

The alert control apparatus 20 according to a first embodiment will now be described.

### Example Structure

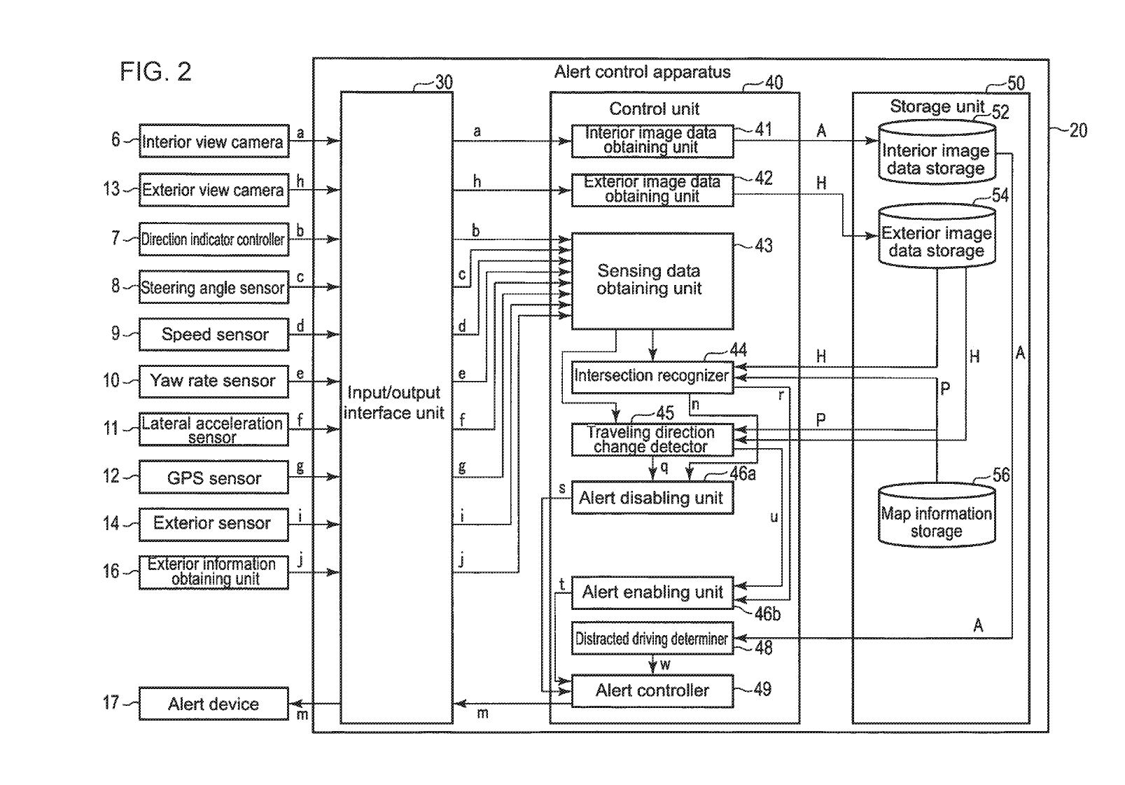

FIG. 2 is a functional block diagram of the alert control apparatus 20 according to the present embodiment.

The alert control apparatus 20 includes an input/output interface unit 30, a control unit 40, and a storage unit 50 as its hardware components.

The input/output interface unit 30 receives an image data signal a output from the interior view camera 6, a direction indicator signal b output from the direction indicator controller 7, a steering angle signal c output from the steering angle sensor 8, a detection signal d output from the speed sensor 9, a detection signal e output from the yaw rate sensor 10, a detection signal f output from the lateral acceleration sensor 11, a detection signal g output from the GPS sensor 12, an image data signal h output from the exterior view camera 13, a sensing signal i output from the exterior sensor 14, and a reception signal j output from the exterior information obtaining unit 16. The input/output interface unit 30 outputs these signals to the control unit 40. The input/output interface unit 30 also outputs an alert instruction signal m received from the control unit 40 to the alert device 17.

The storage unit 50 uses a nonvolatile memory as a storage medium, such as a solid state drive (SSD) or a hard disk drive (HDD), which is writable and readable as appropriate. The storage unit 50 includes, as storage areas according to the present embodiment, an interior image data storage 52, an exterior image data storage 54, and a map information storage 56.

The control unit 40 includes a central processing unit (CPU) and a program memory, which are included in a computer. The control unit 40 includes, as control functions according to the present embodiment, an interior image data obtaining unit 41, an exterior image data obtaining unit 42, a sensing data obtaining unit 43, an intersection recognizer 44, a traveling direction change detector 45, an alert disabling unit 46a, an alert enabling unit 46b, a distracted driving determiner 48, and an alert controller 49. These control functions are implemented by the CPU executing a program stored in the program memory.

The interior image data obtaining unit 41 receives image data signals a captured by the interior view camera 6 and output from the input/output interface unit 30, and stores the signals into the interior image data storage 52 as image data A. Thus, the interior image data storage 52 stores the image data A representing the state of the driver.

The exterior image data obtaining unit 42 receives image data signals h captured by the exterior view camera 13 and output from the input/output interface unit 30, and stores the signals into the exterior image data storage 54 as image data H. Thus, the exterior image data storage 54 stores the image data H representing the front state of the vehicle 1.

The distracted driving determiner 48 outputs a detection signal w to the alert controller 49 in response to distracted driving of the driver being detected based on the image data A stored in the interior image data storage 52 and a predetermined criterion. Examples of the criterion may include, but not limited to, an allowable duration allowing distracted driving of the driver. When the distracted driving determiner 48 uses the allowable duration as the criterion and determines, from the image data A, that the duration of distracted driving of the driver reaches or exceeds the allowable duration, the distracted driving determiner 48 outputs a detection signal w to the alert controller 49 to cause the alert device 17 to generate an alert.

In response to the detection signal w output from the distracted driving determiner 48, the alert controller 49 outputs the alert instruction signal m to the input/output interface unit 30. The input/output interface unit 30 outputs the alert instruction signal m to the alert device 17.

The alert device 17 includes, for example, a speaker, a display, a light emitter, and a vibrator. In response to the alert instruction signal m output from the input/output interface unit 30, the alert device 17 generates an alert. Examples of the alert include a buzzer or chime sound, a voice message, a display message, lighting or blinking of light, and vibrations. Examples of the alert also include an alert generated in response to the alert instruction signal m transmitted to a mobile terminal carried by the driver. The alert device 17 thus generates an alert to the distracted driver.

In response to an intersection being recognized by the intersection recognizer 44 and an operation to change the traveling direction of the vehicle 1 being detected by the traveling direction change detector 45, the alert control apparatus 20 causes the alert disabling unit 46a to disable distracted driving determination performed by the distracted driving determiner 48 until the vehicle 1 finishes passing the intersection. After the vehicle 1 finishes passing the intersection, the alert control apparatus 20 causes the alert enabling unit 46b to enable the distracted driving alert performed by the alert disabling unit 46a to allow the alert device 17 to resume generating an alert. This structure will be described below.

The sensing data obtaining unit 43 receives the direction indicator signal b, the steering angle signal c, the detection signal d, the detection signal e, the detection signal f, the detection signal g, the sensing signal i, and the reception signal j output from the input/output interface unit 30, and outputs these signals to the intersection recognizer 44 and the traveling direction change detector 45. Thus, the intersection recognizer 44 and the traveling direction change detector 45 obtain direction indicator information B from the direction indicator signal b, steering angle information C from the steering angle signal c, speed information D from the detection signal d, yaw rate information E from the detection signal e, lateral acceleration information F from the detection signal f, position information G from the detection signal g, sensing information I from the sensing signal i, and traffic and other information J from the reception signal j.

When the intersection recognizer 44 recognizes an intersection within a predetermined distance (e.g., within 50 m) ahead of the vehicle 1 in the traveling direction based on at least the position information G, the traffic and other information J, the image data H stored in the exterior image data storage 54, or map information P stored in the map information storage 56, the intersection recognizer 44 outputs an intersection recognition signal n to the alert disabling unit 46a.

When the intersection recognizer 44 no longer recognizes an intersection within the predetermined distance ahead of the vehicle 1 in the traveling direction based on at least the position information G, the traffic and other information J, the image data H, or the map information P, the intersection recognizer 44 outputs an intersection-undetected signal r to the alert enabling unit 46b.

The traveling direction change detector 45 detects an operation to change the traveling direction of the vehicle 1 based on at least the direction indicator information B, the steering angle information C, the yaw rate information E, or the lateral acceleration information F, and additionally at least the position information G, the traffic and other information J, the map information P, or the image data H as appropriate. A change in the traveling direction is not necessarily limited to a right or left turn and includes a lane change to a left-turn lane or a right-turn lane.

The traveling direction change detector 45 outputs a change detection signal q to the alert disabling unit 46a in response to detection of an operation to change the traveling direction of the vehicle 1. The traveling direction change detector 45 outputs a change-undetected signal u to the alert enabling unit 46b when no longer detecting an operation to change the traveling direction.

The alert disabling unit 46a outputs the disabling signal s to the alert controller 49 for disabling the detection signal w from the distracted driving determiner 48 in response to the intersection recognition signal n output from the intersection recognizer 44 and the change detection signal q output from the traveling direction change detector 45.

In response to the disabling signal s output from the alert disabling unit 46a, the alert controller 49 does not output the alert instruction signal m to the input/output interface unit 30 irrespective of whether it has received the detection signal w from the distracted driving determiner 48. Thus, the alert device 17 generates no alert.

The alert enabling unit 46b outputs an enabling signal t to the alert controller 49 to stop output of the disabling signal s from the alert disabling unit 46a in response to the intersection-undetected signal r output from the intersection recognizer 44 or the change-undetected signal u output from the traveling direction change detector 45.

In response to the enabling signal t output from the alert enabling unit 46b, the output of the disabling signal s from the alert disabling unit 46a is stopped. Thereafter, the alert controller 49 outputs the alert instruction signal m in response to the detection signal w output from the distracted driving determiner 48. Thus, the alert device 17 generates an alert when detecting distracted driving.

As described above, while the vehicle 1 is traveling, the alert control apparatus 20 causes the alert device 17 to generate an alert in response to distracted driving of the driver being detected. In response to an intersection being recognized and an operation to change the traveling direction of the vehicle 1 being detected, the alert control apparatus 20 disables the distracted driving alert until the vehicle 1 finishes passing the intersection. The alert control apparatus 20 thus prevents an unintended alert from being generated for a checking action of the driver at the intersection. After the vehicle 1 has passed the intersection, the alert control apparatus 20 enables the distracted driving alert to allow the alert device 17 to generate an alert.

### Operation

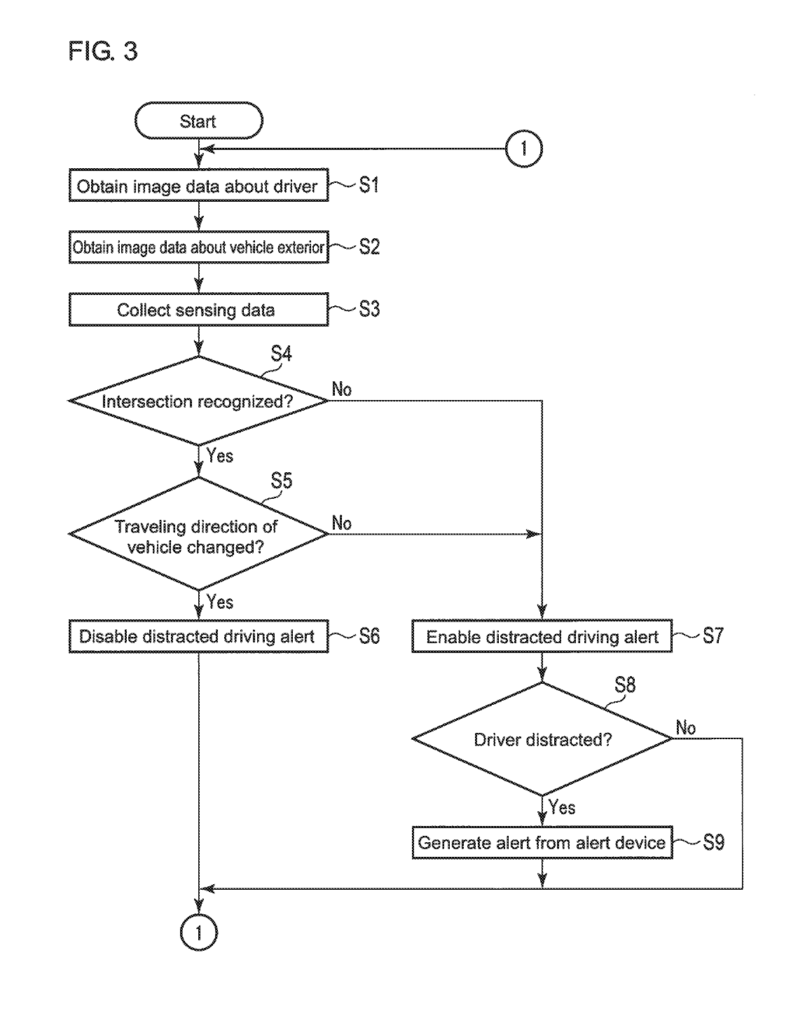

An example operation of the alert control apparatus 20 with the above structure according to the present embodiment will now be described with reference to the flowchart in FIG. 3.

The interior view camera 6 outputs the image data signal a corresponding to the state of the driver to the alert control apparatus 20. The image data signal a is obtained by the interior image data obtaining unit 41 through the input/output interface unit 30, output by the interior image data obtaining unit 41, and stored in the interior image data storage 52 as image data A (S1).

The exterior view camera 13 outputs the image data signal h corresponding to the captured image in front of the vehicle 1 to the alert control apparatus 20. The image data signal h is obtained by the exterior image data obtaining unit 42 through the input/output interface unit 30, output by the exterior image data obtaining unit 42, and stored in the exterior image data storage 54 as image data H (S2).

Further, the signals corresponding to the results detected by the direction indicator controller 7, the steering angle sensor 8, the speed sensor 9, the yaw rate sensor 10, the lateral acceleration sensor 11, the GPS sensor 12, the exterior sensor 14, and the exterior information obtaining unit 16 are also output to the alert control apparatus 20. These signals are collected by the sensing data obtaining unit 43 through the input/output interface unit 30, and output to the intersection recognizer 44 and the traveling direction change detector 45 from the sensing data obtaining unit 43 (S3).

In this manner, the intersection recognizer 44 and the traveling direction change detector 45 obtain the direction indicator information B from the direction indicator signal b, the steering angle information C from the steering angle signal c, the speed information D from the detection signal d, the yaw rate information E from the detection signal e, the lateral acceleration information F from the detection signal f, the position information G from the detection signal g, the sensing information I from the sensing signal i, and the traffic and other information J from the reception signal j.

The flowchart in FIG. 3 includes steps S1 to S3 as separate steps, but these steps are performed in parallel.

When an intersection is located within the predetermined distance (e.g., within 50 m) ahead of the vehicle 1 in the traveling direction (Yes in S4), the intersection recognizer 44 recognizes the intersection based on at least the position information G, the traffic and other information J, the image data H, or the map information P. In response to the intersection being recognized, the intersection recognizer 44 outputs the intersection recognition signal n to the alert disabling unit 46a.

When the intersection recognizer 44 no longer recognizes an intersection within a predetermined distance ahead of the vehicle 1 in the traveling direction based on at least the position information G, the traffic and other information J, the image data H, or the map information P (No in S4), the intersection recognizer 44 outputs the intersection-undetected signal r to the alert enabling unit 46b.

The traveling direction change detector 45 then detects an operation to change the traveling direction of the vehicle 1. Specifically, the traveling direction change detector 45 detects a change based on at least the direction indicator information B, the steering angle information C, the yaw rate information E, or the lateral acceleration information F, and additionally at least the position information G, the traffic and other information J, the map information P, or the image data H as appropriate. When an operation to change the traveling direction of the vehicle 1 is detected (Yes in S5), the traveling direction change detector 45 outputs a change detection signal q to the alert disabling unit 46a. When no operation to change the traveling direction is detected (No in S5), the traveling direction change detector 45 outputs the change-undetected signal u to the alert enabling unit 46b.

Although step S5 is performed only after an intersection is recognized in step S4 (Yes in S4) in FIG. 3, step S5 is performed also after no intersection is recognized in step S4 (No in S4). However, the distracted driving alert remains enabled when no intersection is recognized in S4 (No in S4). Thus, FIG. 3 does not show detecting an operation to change the traveling direction after no intersection is recognized in step S4.

In response to the intersection recognition signal n and the change detection signal q output to the alert disabling unit 46a (Yes in S4, and Yes in S5), the alert disabling unit 46a outputs the disabling signal s to the alert controller 49 to disable the detection signal w from the distracted driving determiner 48. In response to the disabling signal s, the alert controller 49 does not output the alert instruction signal m in response to the detection signal w from the distracted driving determiner 48. Thus, the distracted driving alert is disabled and the alert device 17 generates no alert (S6). The processing then returns to step S1.

Thereafter, in response to the intersection-undetected signal r output to the alert enabling unit 46b in step S4 (No in S4) or in response to the change-undetected signal u output to the alert enabling unit 46b in step S5 (No in S5), the alert enabling unit 46b outputs the enabling signal t to the alert controller 49 to stop output of the disabling signal s from the alert disabling unit 46a. In response to the enabling signal t, the output of the disabling signal s from the alert disabling unit 46a is stopped (S7). Thereafter, the alert controller 49 outputs the alert instruction signal m in response to the detection signal w output from the distracted driving determiner 48. Thus, the alert device 17 generates an alert (S9) when the duration of distracted driving of the driver reaches or exceeds the allowable duration and distracted driving is detected (Yes in S8). The processing then returns to step S1.

When the duration of distracted driving of the driver is determined to fall within the allowable duration in step S8 (No in S8), the distracted driving determiner 48 outputs no detection signal w, and thus the alert device 17 generates no alert.

### Advantages and Effects

As described above, while the vehicle 1 is traveling, the alert control apparatus 20 can cause the alert device 17 to generate an alert in response to distracted driving of the driver being detected. Further, in response to an intersection being recognized and an operation to change the traveling direction of the vehicle 1 being detected, the alert control apparatus 20 can disable the distracted driving alert until the vehicle 1 finishes passing the intersection. The alert control apparatus 20 thus prevents an unintended alert from being generated for a checking action of the driver for changing the traveling direction at the intersection. After the vehicle 1 has passed the intersection, the alert control apparatus 20 stops output of the disabling signal s. The alert device 17 can thereafter generate an alert in response to detection of distracted driving.

### Second Embodiment

An alert control apparatus according to a second embodiment will now be described with reference to the drawings.

### Structure

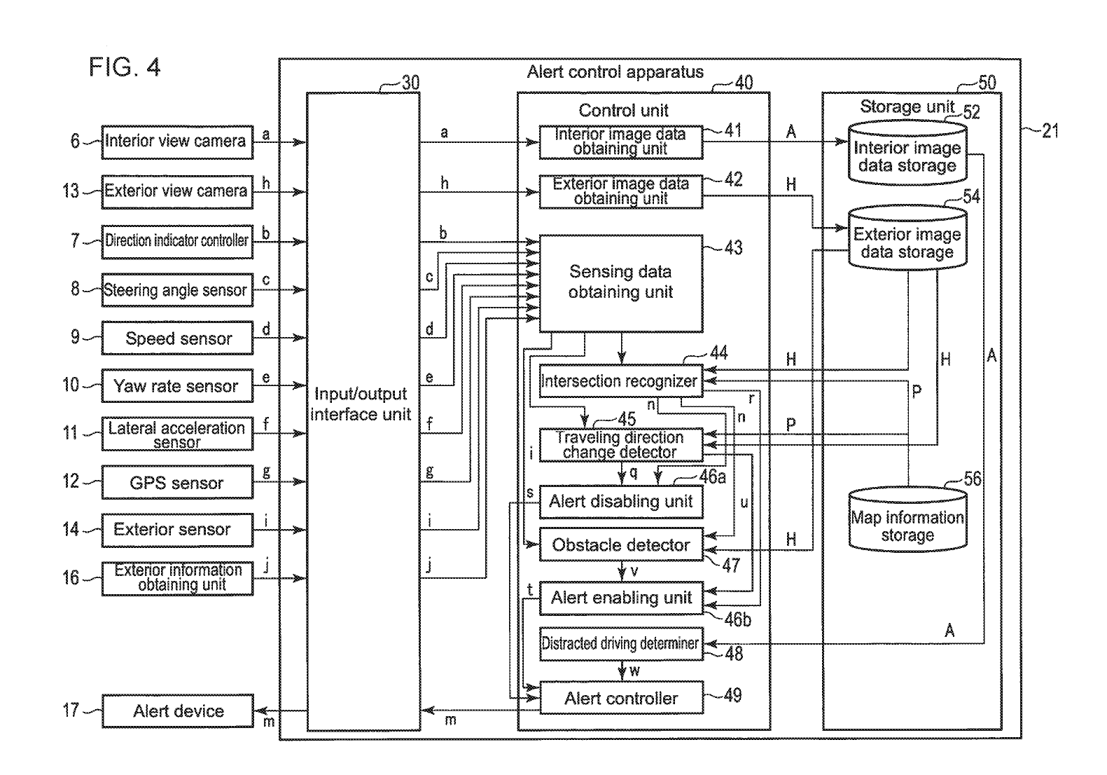

FIG. 4 is a functional block diagram of an alert control apparatus 21 according to the second embodiment.

The alert control apparatus 21 is a modification of the alert control apparatus 20. The alert control apparatus 21 detecting an obstacle does not disable a distracted driving alert when recognizing an intersection, and causes the alert device 17 to generate an alert in response to detection of distracted driving of a driver.

The alert control apparatus 21 replaces the alert control apparatus 20 in FIG. 1. As described above, the alert control apparatus 21 is a modification of the alert control apparatus 20. The components of the alert control apparatus 21 different from those of the alert control apparatus 20 will be described below, and the same components as those of the alert control apparatus 20 are given the same reference numerals, and will not be described repeatedly.

As shown in FIG. 4, the alert control apparatus 21 includes an obstacle detector 47, in addition to the components of the alert control apparatus 20 in FIG. 2.

The sensing data obtaining unit 43 outputs a state information signal i, which has been output from the exterior sensor 14, to the obstacle detector 47. The state information signal i is information about the distance to an object around the vehicle 1. Thus, the obstacle detector 47 obtains, from the state information signal i, distance information I about the distance to an object around the vehicle 1.

The intersection recognizer 44 outputs the intersection recognition signal n also to the obstacle detector 47.

The obstacle detector 47 obtains image data H from the exterior image data storage 54.

When the obstacle detector 47 receives the intersection recognition signal n output from the intersection recognizer 44, and detects an obstacle (e.g., other vehicles, humans, buildings, signs, and signals) within a predetermined distance (e.g., within 10 m) ahead in the traveling direction based on the distance information I and the image data H, the obstacle detector 47 determines that the vehicle 1 may collide with the object, and outputs a detection signal v to the alert enabling unit 46b.

When the alert enabling unit 46b receives the detection signal v from the obstacle detector 47, the alert enabling unit 46b outputs the enabling signal t to the alert controller 49 to stop output of the disabling signal s from the alert disabling unit 46a.

In response to the enabling signal t from the alert enabling unit 46b, the output of the disabling signal s from the alert disabling unit 46a is stopped. Thereafter, the alert controller 49 outputs the alert instruction signal m in response to the detection signal w output from the distracted driving determiner 48. Thus, the alert device 17 generates an alert when detecting distracted driving.

### Operation

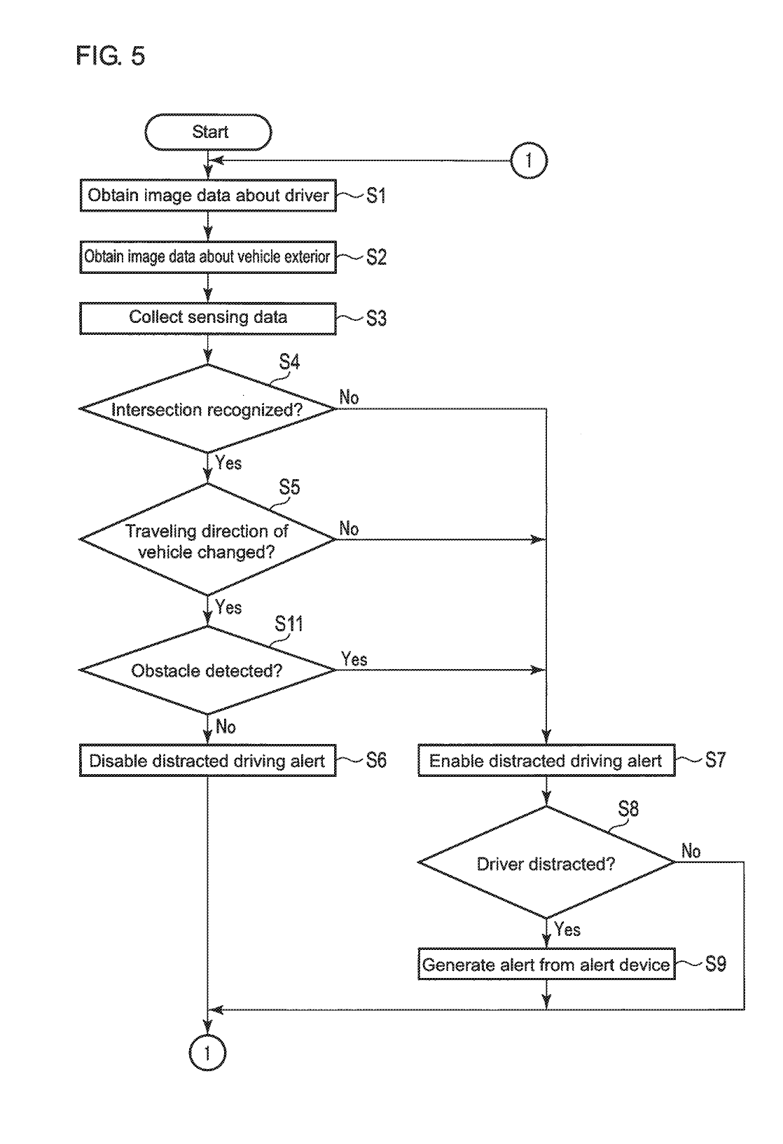

The operation of the alert control apparatus 21 with the above structure according to the present embodiment will now be described using the flowchart in FIG. 5.

The flowchart in FIG. 5 includes additional step S11 between steps S5 and S6 in the flowchart in FIG. 3.

Thus, step S11 will be described in detail below, whereas the steps that are the same as in FIG. 3 will not be described or will be described briefly.

In step S4, when an intersection is located within a predetermined distance (e.g., within 50 m) ahead of the vehicle 1 in the traveling direction (Yes in S4), the intersection recognizer 44, as described in the first embodiment, recognizes the intersection and outputs the intersection recognition signal n. In the first embodiment, the intersection recognition signal n is output to the alert disabling unit 46a. In the present embodiment, the intersection recognition signal n is also output to the obstacle detector 47, in addition to the alert disabling unit 46a.

After the intersection is recognized in step S4 (Yes in S4), step S5 is performed. Thereafter, in response to the intersection recognition signal n output from the intersection recognizer 44 in step S4, the obstacle detector 47 determines whether an obstacle (e.g., any of other vehicles, humans, buildings, signs, and signals) is within a predetermined distance (e.g., within 10 m) ahead in the traveling direction based on the distance information I and the image data H. When detecting an obstacle, the obstacle detector 47 determines that the vehicle 1 may collide with the object, and outputs the detection signal v to the alert enabling unit 46b (Yes in S11).

In response to the detection signal v output from the obstacle detector 47, the alert enabling unit 46b outputs the enabling signal t to the alert controller 49 to stop output of the disabling signal s from the alert disabling unit 46a.

In response to the enabling signal t output from the alert enabling unit 46b, the output of the disabling signal s from the alert disabling unit 46a is stopped. Thereafter, the alert controller 49 outputs the alert instruction signal m in response to the detection signal w output from the distracted driving determiner 48. Thus, the alert device 17 generates an alert when detecting distracted driving (S9).

In step S11, when the obstacle detector 47 detects no obstacle (No in S11), the processing advances to step S6.

### Advantages and Effects

As described above, the alert control apparatus 21 detecting an obstacle does not disable the detection signal w from the distracted driving determiner 48 when recognizing an intersection. Thus, the alert device 17 can generate an alert in response to detection of distracted driving.

As described in the first embodiment, in response to an intersection being recognized and an operation to change the traveling direction being detected without detection of an obstacle, the disabling signal s can disable the detection signal w from the distracted driving determiner 48 until the vehicle 1 finishes passing the intersection. This can prevent an unintended alert from being generated for a checking action of a driver at the intersection. After the vehicle 1 has passed the intersection, the alert control apparatus 21 stops output of the disabling signal s. Thus, the alert device 17 can generate an alert in response to detection of distracted driving.

As described above, when the vehicle 1 changing its traveling direction at an intersection, the distracted driving alert is disabled to prevent an unintended alert from being generated. In addition, when the vehicle 1 changing the traveling direction at the intersection has an obstacle ahead, the alert device 17 does not disable the distracted driving alert and thus can generate an alert in response to distracted driving.

### Other Embodiments

Although the present invention has been described based on the specific embodiments with reference to the appended drawings, the present invention is not limited to the above embodiments. Variations and modifications may occur to those skilled in the art within the spirit and scope of the present invention defined by the claims. Such variations and modifications can fall within the technical scope of the present invention.

The present embodiment may be partially or entirely expressed in, but not limited to, the following forms shown in the appendixes below.

### Appendix 1

An alert control apparatus for controlling an alert device installed on a vehicle, the apparatus comprising a hardware processor configured to

obtaining first information about a gaze or a face orientation of a driver of the vehicle;

determining whether the driver is engaging in distracted driving based on the gaze or the face orientation of the driver indicated by the first information and a determination condition for detecting distracted driving, and outputting a detection signal when detecting distracted driving;

obtaining second information indicating whether an intersection is recognized ahead of the vehicle in a traveling direction;

obtaining third information about a change in the traveling direction of the vehicle;

outputting a disabling signal for disabling the detection signal in response to the intersection being recognized and the change in the traveling direction being detected based on the second information and the third information; and

outputting an instruction signal for the alert device to generate an alert in response to the detection signal being output without the disabling signal being output, and outputting no instruction signal in response to the detection signal being output with the disabling signal being output.

### Appendix 2

An alert control method implemented by a hardware processor for controlling an alert device installed on a vehicle, the method comprising:

obtaining, with the hardware processor, first information about a gaze or a face orientation of a driver;

determining, with the hardware processor, whether the driver is engaging in distracted driving based on the gaze or the face orientation of the driver indicated by the first information and a determination condition for detecting distracted driving, and outputting a detection signal when detecting distracted driving;

obtaining, with the hardware processor, second information indicating whether an intersection is recognized ahead of the vehicle in a traveling direction;

obtaining, with the hardware processor, third information about a change in the traveling direction of the vehicle;

outputting, with the hardware processor, a disabling signal for disabling the detection signal in response to the intersection being recognized and the change in the traveling direction being detected based on the second information and the third information; and

outputting, with the hardware processor, an instruction signal for the alert device to generate an alert in response to the detection signal being output without the disabling signal being output, and outputting no instruction signal, with the hardware processor, in response to the detection signal being output with the disabling signal being output.

1. An alert control apparatus, comprising:
a first obtaining unit configured to obtain first information about a gaze or a face orientation of a driver of a vehicle;
a distracted driving determiner configured to determine whether the driver is engaging in distracted driving based on the gaze or the face orientation of the driver indicated by the first information and a determination condition for detecting distracted driving, and output a detection signal when detecting distracted driving;
a second obtaining unit configured to obtain second information indicating whether an intersection is recognized ahead of the vehicle in a traveling direction;
a third obtaining unit configured to obtain third information about a change in the traveling direction of the vehicle;
an alert disabling unit configured to output a disabling signal for disabling the detection signal output from the distracted driving determiner in response to the intersection being recognized and the change in the traveling direction being detected based on the second information and the third information; and
an alert controller configured to output an instruction signal for an alert device to generate an alert in response to the detection signal being output without the disabling signal being output, and configured to output no instruction signal in response to the detection signal being output with the disabling signal being output.

2. The alert control apparatus according to claim 1, further comprising:
an alert enabling unit configured to output an enabling signal to the alert controller to stop output of the disabling signal to the alert controller in response to the vehicle being determined to have passed the intersection based on the second information.

3. The alert control apparatus according to claim 1, further comprising:
a fourth obtaining unit configured to obtain fourth information indicating whether an obstacle with a possibility of colliding with the vehicle is detected; and
an alert enabling unit configured to output an enabling signal to the alert controller to stop output of the disabling signal to the alert controller in response to the obstacle being detected based on the fourth information.

4. The alert control apparatus according to claim 3, wherein
the fourth obtaining unit obtains information output from an exterior sensor configured to detect a state surrounding the vehicle and/or information obtained from another vehicle or a system, and to obtain, based on the obtained information, the fourth information indicating whether an obstacle with a possibility of colliding with the vehicle is detected.

5. The alert control apparatus according to claim 1, wherein
the second obtaining unit obtains at least image information obtained by an exterior view camera installed on the vehicle to capture an image in front of the vehicle, position information about the vehicle measured by a position measurement sensor installed on the vehicle, or traffic information received by an exterior information obtaining unit installed on the vehicle, and obtains, based on the obtained information, the second information indicating whether an intersection is recognized ahead of the vehicle in the traveling direction.

6. The alert control apparatus according to claim 1, wherein
the third obtaining unit obtains at least operation information about a direction indicator installed on the vehicle, steering angle information about a steering unit installed on the vehicle, yaw rate information obtained by a yaw rate sensor installed on the vehicle, or lateral acceleration information obtained by a lateral acceleration sensor installed on the vehicle, and obtains, based on the obtained information, the third information about a change in the traveling direction of the vehicle.

7. A method implemented by an alert control apparatus for controlling an alert device installed on a vehicle, the method comprising:
obtaining, with the alert control apparatus, first information about a gaze or a face orientation of a driver;
determining, with the alert control apparatus, whether the driver is engaging in distracted driving based on the gaze or the face orientation of the driver indicated by the first information and a determination condition for detecting distracted driving, and outputting a detection signal when detecting distracted driving;
obtaining, with the alert control apparatus, second information indicating whether an intersection is recognized ahead of the vehicle in a traveling direction;
obtaining, with the alert control apparatus, third information about a change in the traveling direction of the vehicle;
outputting, with the alert control apparatus, a disabling signal for disabling the detection signal in response to the intersection being recognized and the change in the traveling direction being detected based on the second information and the third information; and
outputting, with the alert control apparatus, an instruction signal for the alert device to generate an alert in response to the detection signal being output without the disabling signal being output, and outputting, with the alert control apparatus, no instruction signal in response to the detection signal being output with the disabling signal being output.

8. A program causing a computer to function as the units included in the alert control apparatus according to claim 1.

9. A program causing a computer to function as the units included in the alert control apparatus according to claim 2.

10. A program causing a computer to function as the units included in the alert control apparatus according to claim 3.

11. A program causing a computer to function as the units included in the alert control apparatus according to claim 4.

12. A program causing a computer to function as the units included in the alert control apparatus according to claim 5.

13. A program causing a computer to function as the units included in the alert control apparatus according to claim 6.
